(19) United States
(12) Patent Application Publication
(10) Pub. No.: US 2010/0058556 A1
(43) Pub. Date: Mar. 11, 2010

(54) HINGE AND COLLAPSIBLE DEVICE UTILIZING THE SAME

(75) Inventor: Wei-Chen Kao, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/331,408

(22) Filed: Dec. 9, 2008

(30) Foreign Application Priority Data
Sep. 8, 2008 (CN) 200820302052.4

(51) Int. Cl. E05D 11/00; E05D 7/00

(52) U.S. Cl. 16/250; 16/362

(57) ABSTRACT

A hinge includes a first connecting member defining a through hole, a second connecting member, a shaft, a receiving member, and at least one sliding member. The shaft is fixed to the second connecting member, and a distal end of the shaft is passed through the through hole of the first connecting member. The receiving member is fixed to the first connecting member, and defines a receiving space for receiving the at least one sliding member. A sidewall of the receiving space defines a groove. The sliding member is fixed to the shaft, and rotated together with the shaft. A protrusion extends from a circumference of each of the at least one sliding member. When the sliding member rotates relative to the receiving member in the receiving space, the protrusion is engaged with or disengaged from the groove.

### BACKGROUND

1. Technical Field

The present disclosure relates to hinges and collapsible devices utilizing the hinges and, particularly, to a collapsible device and a hinge for same.

2. Description of Related Art

A collapsible device, such as a notebook computer, or a clamshell mobile phone, generally including a main body and a display, often uses a hinge to interconnect the main body and the display. The hinge allows the display to be rotational with respect to the main body, and to be folded with the main body for saving space.

A hinge normally includes a male interference member and a female interference member fixed to the main body and the display of the collapsible device, respectively. The male interference member includes a first raised portion and a second raised portion. The female interference member includes a first depressed portion and a second depressed portion respectively for receiving the first and second raised portions. When the male and the female interference members are rotational relative to each other, the first and second raised portions are in friction engagement with the corresponding first and second depressed portions. As a result, the display can be maintained at any angle with respect to the main body by friction between the male and female interference members. However, the male and female interference members are not durable. After frequent usage and due to wear and tear, the male and female interference members may no longer fit together tightly, thereby preventing the display from being able to stay at certain desirable positions. Even worse, when the male interference member or the female interference member wears out, the display cannot maintain stability at almost any angle with respect to the main body, which is inconvenient for users.

### BRIEF DESCRIPTION OF THE DRAWINGS

FIG. 1 is an exploded, isometric view of an exemplary embodiment of a hinge including a receiving member, and an interference member.

FIG. 2 is similar to FIG. 1, but viewed from another perspective.

FIG. 3 is an assembled, isometric view of the receiving member and the interference member of FIG. 2.

FIG. 4 is an assembled, isometric view of the hinge of FIG. 1.

FIG. 5 is an isometric view of an exemplary embodiment of a collapsible device utilizing the hinge of FIG. 1.

### DETAILED DESCRIPTION

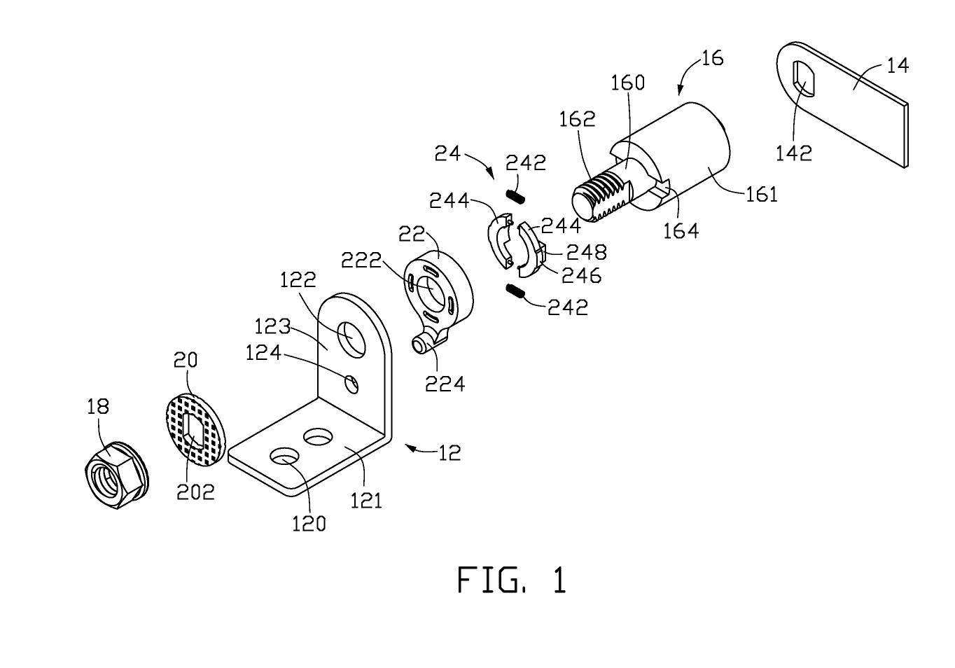

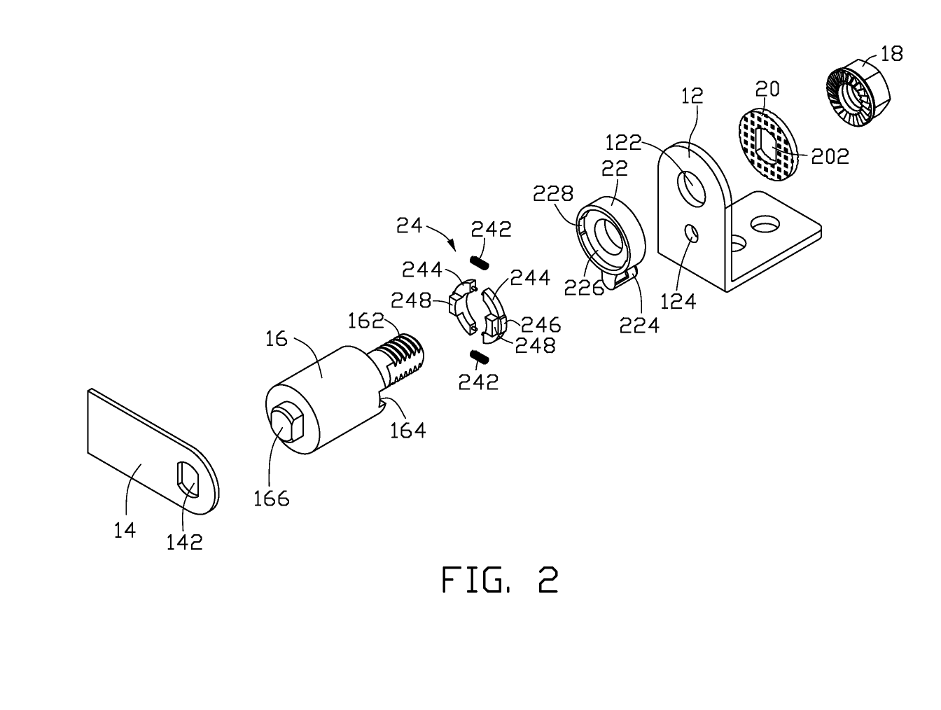

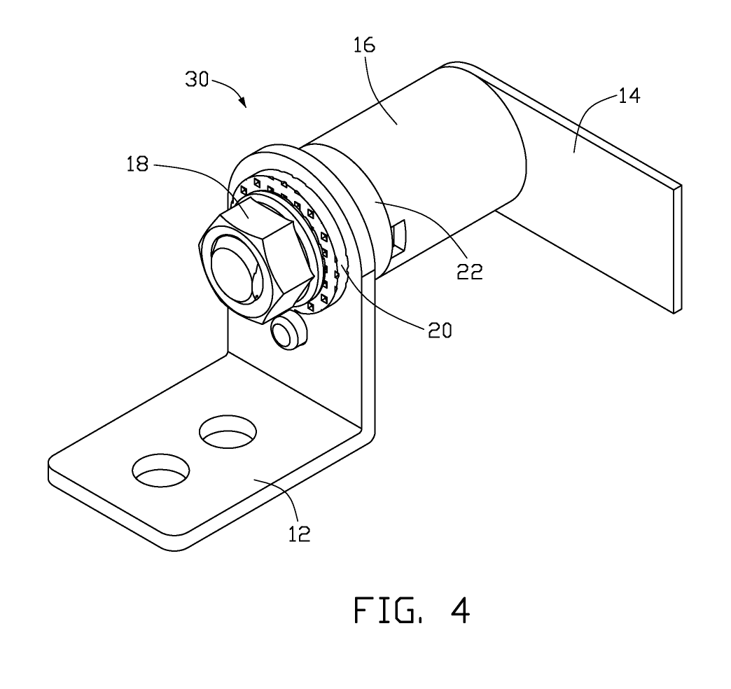

Referring to FIGS. 1 and 2, an exemplary embodiment of a hinge 30 (shown in FIG. 4) includes a first connecting member 12, a shaft 16, a second connecting member 14, a friction member 20, a receiving member 22, an interference member 24, and a fastener 18.

The first connecting member 12 is L-shaped and includes a plurality of fixing holes 120 defined in a first portion 121, and a second portion 123 perpendicularly extending from the first portion 121. The second portion 123 defines a round through hole 122 for the shaft 16 rotatably passing through, and a fixing hole 124 adjacent to the through hole 122.

The second connecting member 14 defines a noncircular, such as double-D shaped, fixing hole 142.

The shaft 16 includes a cylindrical main body 161, a fixing rod 160 having a portion with double-D shaped cross-section and extending from a first end of the main body 161, and a conjoining portion 166 having a double-D shaped cross-section and extending from a second end of the main body 161. The first end of the main body 161 defines two slots 164 opposite to each other across the fixing rod 160. The slots 164 each extend along a radial direction towards the central axis until abutting the fixing rod 160. The fixing rod 160 defines a threaded portion 162 on a distal end opposite to the main body 161.

The friction member 20 defines a double-D shaped through hole 202 for engaging the fixing rod 160. The shape of the through hole 202 corresponds to the cross-section of the fixing rod 160, and thus, the friction member 20 and the shaft 16 are immovable with each other. The friction member 20 also defines a plurality of recessed portions (not labeled) for retaining lubricant.

The receiving member 22 defines a round shaft hole 222 for the fixing rod 160 passing through, thereby allowing the shaft 16 rotating freely relative to the receiving member 22. A fixing post 224 extends from a circumference of the receiving member 22, away from the interference member 24, and is configured for engaging with the fixing hole 124 of the first connecting member 12, thereby the receiving member 22 is immovably fixed to the first connecting member 12.

The receiving member 22 defines a round receiving space 226 opposite to the fixing post 224 and communicating with the shaft hole 222. A sidewall of the receiving space 226 defines two grooves 228 opposite to each other across the shaft hole 222. The ends of the grooves 228 each include a slanting connecting portion connected to the sidewall of the receiving space 226.

The interference assembly 24 includes two sliding members 244 slidably received in the receiving space 226, and two resilient members 242, such as coil springs. One resilient member 242 is located between first ends of the sliding members 244, and the other resilient member 242 is located between second ends of the sliding members 244, for driving the sliding members 244 away from each other. Each sliding member 244 is substantially an arced shaped, so the sliding members 244 can be arranged in the round receiving space 226 to bound an annular shape. In other embodiments, the sliding members 244 are elastic, so that the sliding members 244 may move away from each other directly by elasticity thereof. As a result, the resilient members 242 may be omitted.

A fixing portion 248 protrudes from a middle of a side opposite to the receiving member 22 of each sliding member 244 for slidably engaging with the corresponding slots 164. Therefore, each sliding member 244 can rotate with the shaft 16, by moving in the corresponding slots 164 along a radial direction. A protrusion 246 axially protrudes out from a circumference of each sliding member 244. Each end of the protrusion 246 includes a slanting connecting portion connected to the circumference of the sliding member 244.

In one embodiment, the interference assembly 24 may only include one sliding member 244 with one protrusion 246, and the sidewall of the receiving space 226 may define one groove 228 for being engagable with the protrusion 246. Obviously, the sidewall of the receiving space 226 may define a plurality of grooves 228, when the one sliding member 244 is rotated, the protrusion 246 can engage with any one of the plurality of grooves 228. Correspondingly, in other embodiments, the interference assembly 24 can include a plurality of sliding members 244 each including one protrusion 246, and the sidewall of the receiving space 226 may define a plurality of groove 228 for being engagable with the corresponding protrusions 246. Obviously, the sidewall of the receiving space 226 may only define one groove 228, when the plurality of sliding members 244 are rotated, the protrusions 246 each can engage with the one groove 228 in turn.

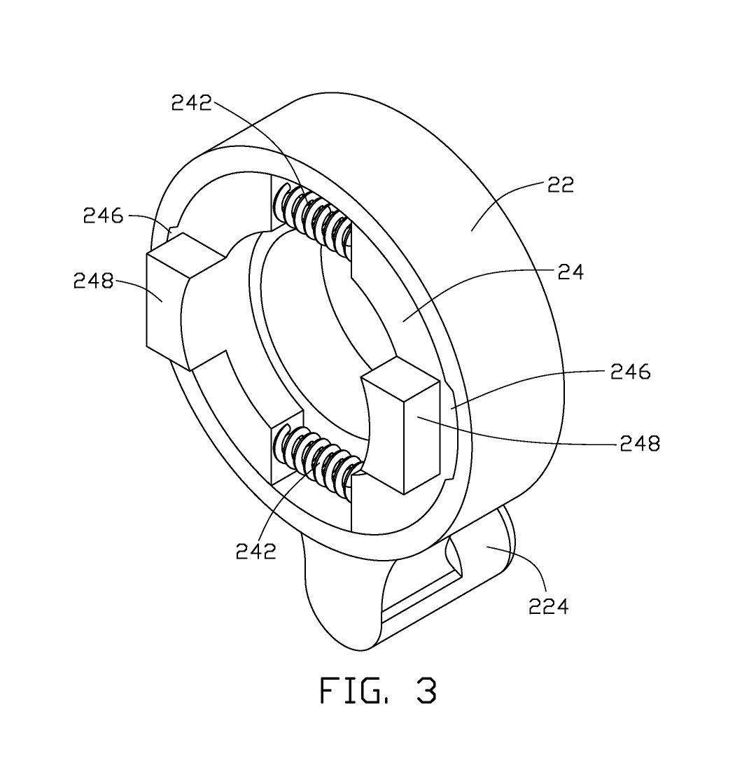

Referring to FIGS. 3 and 4, in assembly, each resilient member 242 is mounted between the sliding members 244, and put into the receiving space 226 together with the sliding members 244. At this time, the protrusions 246 are engaged with the corresponding grooves 228. The conjoining portion 166 of the shaft 16 is inserted into and fixed in the fixing hole 142 of the second connecting member 14, thereby the shaft 16 is rotatable together with the second bracket 14. The fixing rod 160 is passed through interference member 24, the shaft hole 222 of the receiving member 22, the through hole 122 of the first connecting member 12, and the through hole 202 of the friction member 20 in turn. The fastener 18 is engaged with the threaded portion 162 for fixing the fastener 18 to the fixing rod 160, to prevent the friction member 20, the first connecting member 12, and the receiving member 22 from disengaging from the fixing rod 160.

In the aforementioned assembly, the fixing post 224 is inserted into the fixing hole 124 of the first connecting member 12, thereby, allowing the first connecting member 12 to non-rotationally fit about the fixing post 224 of the receiving member 22. Accordingly, the interference assembly 24 received in the receiving space 226 resists against the first end of the main body 161. The fixing portions 248 are engaged with the corresponding slots 164. Therefore, the sliding members 244 are fixed to the shaft 16, and rotated together with the shaft 16 in the receiving space 226. The friction member 20 is immovably fixed to the fixing rod 160 between the first connecting member 12 and the fastener 18. As a result, the first connecting member 14, the shaft 16, the sliding members 244, and the friction member 20 rotate together relative to the receiving member 22 and the first connecting member 12.

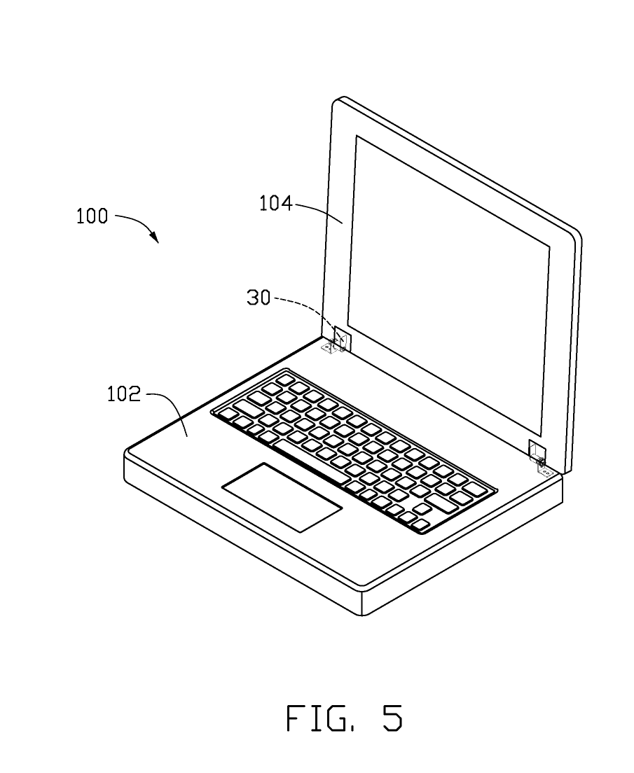

Referring to FIG. 5, in use, the above-mentioned hinge 30 is utilized in a collapsible device 100, here for instance, in a notebook computer that includes a base 102 and a cover 104. The fixing holes 120 are configured for allowing fastening members, such as screws, bolts, or rivets, etc., to extend through, thereby fixing the first connecting member 12 to one of the cover 104 and the base 102. Similarly, the second connecting member 14 is fixed to the other one of the cover 104 and the base 102. Therefore, during the rotation of the cover 104 or the base 102, the second connecting member 14 is rotated relative to the first connecting member 12, with the shaft 16, the sliding members 244, and the friction member 20. As a result, the protrusions 246 of the sliding members 244 can move out from the corresponding grooves 228 to slide along the sidewall of the receiving space 226, and resist against the sidewall of the receiving space 226. Thus, the sliding members 244 are compressed to shrink toward each other, with the fixing portions 248 moving towards the fixing rod 160 in the corresponding slots 164. As a result, the resilient members 242 are distorted, and the sliding members 244 clamp the fixing rod 160, resulting in increasing friction between the fixing rod 160 and the sliding members 244. Accordingly, friction among the fixing rod 160 and the sliding members 244 keeps the cover 104 stably at any angle with respect to the base 102. In addition, when the cover 104 is folded towards the base 102, the protrusions 246 slide to enter into the corresponding grooves 228. When the protrusions 246 are positioned at edges of the corresponding grooves 228, the cover 102 may be physically released and the resilient members 242 restore for driving the corresponding sliding members 244 to rotate unceasingly. As a result, the protrusions 246 enter into the corresponding grooves 228, and each sliding member 244 resists against the sidewall of the receiving space 226. At this movement, the sliding members 244 bounded by the sliding members 244 gradually restore to the positions with the protrusions 246 received in the corresponding grooves 228, resulting in reducing friction. Therefore, the shaft 16 is rotated smoothly by little force, so that the cover 104 is easy to be folded on the base 102.

It is believed that the present embodiments and their advantages will be understood from the foregoing description, and it will be apparent that various changes may be made thereto without departing from the spirit and scope of the description or sacrificing all of its material advantages, the examples hereinbefore described merely being exemplary embodiments.

What is claimed is:

1. A hinge comprising:
a first connecting member defining a through hole;
a second connecting member;
a shaft fixed to the second connecting member, wherein a distal end of the shaft is rotatably passed through the through hole of the first connecting member;
a receiving member fixed to the first connecting member, and defining a receiving space, a sidewall of the receiving space defining at least one groove; and
at least one sliding member fixed to the shaft and received in the receiving space, wherein the at least one sliding member is received in and rotated with the shaft relative to the receiving space, at least one protrusion extending from a circumference of each of the at least one sliding member;
wherein when the at least one sliding member rotates relative to the receiving member in the receiving space, the at least one protrusion is engaged with or disengaged from the at least one groove.

2. The hinge of claim 1, wherein the at least one sliding member comprise a plurality of sliding members that are arranged to bound an annular shape, the plurality of sliding members can be axially moved towards or away from each other in the receiving space.

3. The hinge of claim 2, further comprising a plurality of resilient members, wherein every two adjacent sliding members are connected by a corresponding one of the at least one resilient members.

4. The hinge of claim 1, wherein the shaft comprises a main body defining at least one slot axially extending from a side of the main body, a fixing portion protrudes from each of the at least one sliding member, the fixing portion is able to be axially movably engaged with the one of the at least one slot.

5. The hinge of claim 4, wherein the second connecting member defines a fixing hole, a conjoining portion extends from the main body opposite to the at least one slot, for engaging in the fixing hole.

6. The hinge of claim 4, wherein a fixing rod extends from the side of the main body, rotatably passing through the through hole of the first connecting member, the slot is adjacent to the fixing rod.

7. The hinge of claim 1, wherein a fixing post extends from the receiving member, opposite to the receiving space, the first connecting member defines a fixing hole for engaging with the fixing post.

8. A collapsible device comprising:
a base;
a hinge comprising:
a first connecting member defining a through hole;
a second connecting member;
a shaft fixed to the second connecting member, and a distal end of the shaft passed through the through hole of the first connecting member for being rotationally fitted about via the first connecting member;
a receiving member fixed to the first connecting member, and defining a receiving space, a sidewall of the receiving space defining at least one groove; and
at least one sliding member fixed to the shaft and received in the receiving space, the at least one sliding member being received in and rotated relative to the receiving space together with the shaft, at least one protrusion extending from a circumference of each of the at least one sliding member; and
a cover pivotally mounted to the base via the first and the second connecting members of the hinge;
wherein the first connecting member is fixed to one of the cover and the base, and the second connecting member is fixed to the other one of the cover and the base, when the at least one sliding member rotates relative to the receiving member in the receiving space, the at least one protrusion is engaged with or disengaged from the at least one groove.

9. The collapsible device of claim 8, wherein the at least one sliding member comprise a plurality of sliding members that are arranged to bound an annular shape, the plurality of sliding members can be axially moved towards or away from each other in the receiving space.

10. The collapsible device of claim 9, further comprising a plurality of resilient members, wherein every two adjacent sliding members are connected by a corresponding one of the at least one resilient members.

11. The collapsible device of claim 8, wherein the shaft comprises a main body defining at least one slot axially extending from a side of the main body, a fixing portion protrudes from each of the at least one sliding member, the fixing portion is able to be axially movably engaged with the one of the at least one slot.

12. The collapsible device of claim 11, wherein the second connecting member defines a fixing hole, a conjoining portion extends from the main body opposite to the at least one slot, for engaging in the fixing hole.

13. The collapsible device of claim 11, wherein a fixing rod extends from the side of the main body to rotatably pass through the through hole of the first connecting member, the slot is connected to the fixing rod.

14. The collapsible device of claim 8, wherein a fixing post extends from the receiving member, and is opposite to the receiving space, the first connecting member defines a fixing hole for engaging with the fixing post.

15. A hinge comprising:
a shaft;
a receiving member rotatably fitting about the shaft, wherein the receiving member defines a round receiving space, a groove is defined in a sidewall of the receiving space; and
a resilient annular interference member nonrotatably fitting about the shaft and rotatably received in the receiving space, a protrusion axially extending from the interference member, wherein the protrusion is able to be engaged in or disengaged from the groove in response to the shaft rotating; when the protrusion is disengaged from the groove, the protrusion moves along the sidewall of the receiving space to elastically axially shrink the interference member, resulting in the interference member clamping the shaft to help position the shaft.

16. The hinge of claim 15, wherein the shaft comprises a cylindrical main body, a side of the main body axially defines a slot; the interference member comprises a fixing portion axially slidably engaged in the slot.

17. The hinge of claim 16, wherein a fixing rod extending from a center of the first side of the main body, the receiving member rotatably fits about the fixing rod while the interference member nonrotatably fits about the fixing rod, the slot extends from the fixing rod to a circumference of the fixing rod.
